(19) United States
(12) Patent Application Publication
(10) Pub. No.: US 2026/0361491 A1
(43) Pub. Date: Nov. 12, 2026

(54) APPARATUS, METHOD, AND COMPUTER PROGRAM

(71) Applicant: Nokia Technologies Oy, Espoo (FI)

(72) Inventors: Majed SAAD, Massy (FR); Nicolas SCHLEGEL, Massy (FR); Fanny JARDEL, Massy (FR)

(21) Appl. No.: 19/137,885

(22) PCT Filed: Dec. 13, 2022
(86) PCT No.: PCT/EP2022/085553

§ 371 Date: Jun. 11, 2025

(51) Int. Cl. H04L 5/00

(52) U.S. Cl. CPC H04L 5/0051; H04L 5/0091

(57) ABSTRACT

The disclosure relates to an apparatus comprising: means for receiving (1700), from a base station, an indication of a block configuration for a resource block, wherein the block configuration configures at least one reference signal symbol on a pre-defined fixed position in the resource block to convey data via index modulation; and means for receiving (1702), from the base station, the resource block according to the block configuration or means for transmitting (1702), to the base station, the resource block according to the block configuration.

### FIELD OF THE DISCLOSURE

The present disclosure relates to an apparatus, a method, and a computer program for at least one of receiving or transmitting a reference signal and data in a communication system.

For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

### BACKGROUND

A communication system can be seen as a facility that enables communication sessions between two or more entities such as communication devices, base stations or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols or parameters which shall be used for the connection are also typically defined. Examples of standard are the so-called 5G standards.

### SUMMARY

According to an aspect there is provided an apparatus comprising: means for receiving, from a base station, an indication of a block configuration for a resource block, wherein the block configuration configures at least one reference signal symbol on a pre-defined fixed position in the resource block to convey data via index modulation; and means for receiving, from the base station, the resource block according to the block configuration or means for transmitting, to the base station, the resource block according to the block configuration.

The resource block may comprise reference signal symbols and data symbols; and the block configuration may configure all reference signal symbol on pre-defined fixed positions in the resource block to convey data via index modulation.

The resource block may comprise reference signal symbols and data symbols; and the block configuration may configure at least one reference signal symbol on a pre-defined fixed position in the resource block to convey data via index modulation and at least one other reference signal symbol on a pre-defined fixed position in the resource block to not convey data via index modulation.

The resource block may comprise reference signal symbols and may not comprise data symbols; and the block configuration may configure all reference signal symbol on pre-defined fixed positions in the resource block to convey data via index modulation; or the block configuration may configure at least one reference signal symbol on a pre-defined fixed position in the resource block to convey data via index modulation and at least one other reference signal symbol on a pre-defined fixed position in the resource block to not convey data via index modulation.

At least one reference signal symbol on a pre-defined fixed position in the resource block may convey data independently via index modulation.

At least two reference signal symbols on pre-defined fixed positions in the resource block may convey data jointly via index modulation.

The pre-defined fixed positions of the reference signal symbols in the resource block may be known by the apparatus and the base station.

The resource block may be a single carrier resource block or a multicarrier resource block.

The apparatus may comprise: means for transmitting, to the base station, at least one of an indication of whether the apparatus supports a block configuration configuring at least one reference signal symbol on pre-defined fixed position in the resource block to convey data via index modulation or an indication of at least one parameter determined by the apparatus.

The at least one parameter may be measured by the apparatus or known from manufacturing by the apparatus.

The indication may explicitly or implicitly indicate the at least one parameter.

The apparatus may comprise: means for receiving, from the base station, a request to transmit the indication of the at least one parameter.

The at least one parameter may comprise: a channel characteristics where the resource block is transmitted, a type of radio frequency impairment experienced by the apparatus, a level of radio frequency impairment experienced by the apparatus, conditions of a link used for transmitting the resource block, an apparatus class, an apparatus capability.

The apparatus may comprise: means for transmitting, to the base station, an indication of a specific block configuration.

The indication of the block configuration may be received, from the base station, via at least one of: user equipment specific downlink control information, group specific downlink control information, medium access control control element, radio resource control configuration of higher layer signaling.

The index modulation on the at least one reference signal symbol may be performed by selecting a pulse shaping filter amongst a plurality of pulse shaping filters based on the data to be conveyed.

The resource block may be received, from the base station, over a physical downlink control channel or a physical downlink shared channel or transmitted, to the base station over a physical uplink shared channel or a physical uplink control channel.

The resource block may be received, from the base station, or transmitted, to the base station, over a frequency band above 71 GHz; or the resource block may be received, from the base station, or transmitted, to the base station, over a frequency band below 71 GHz.

According to an aspect there is provided an apparatus comprising at least one processor and at least one memory storing instructions that, when executed by the at least one processor, cause the apparatus at least to: receive, from a base station, an indication of a block configuration for a resource block, wherein the block configuration configures at least one reference signal symbol on a pre-defined fixed position in the resource block to convey data via index modulation; and receive, from the base station, the resource block according to the block configuration or transmit, to the base station, the resource block according to the block configuration.

According to an aspect there is provided an apparatus comprising circuitry configured to: receive, from a base station, an indication of a block configuration for a resource block, wherein the block configuration configures at least one reference signal symbol on a pre-defined fixed position in the resource block to convey data via index modulation; and receive, from the base station, the resource block according to the block configuration or transmit, to the base station, the resource block according to the block configuration.

According to an aspect there is provided a method comprising: receiving, from a base station, an indication of a block configuration for a resource block, wherein the block configuration configures at least one reference signal symbol on a pre-defined fixed position in the resource block to convey data via index modulation; and receiving, from the base station, the resource block according to the block configuration or transmitting, to the base station, the resource block according to the block configuration.

According to an aspect there is provided a computer program comprising computer executable code which when run on at least one processor is configured to: receive, from a base station, an indication of a block configuration for a resource block, wherein the block configuration configures at least one reference signal symbol on a pre-defined fixed position in the resource block to convey data via index modulation; and receive, from the base station, the resource block according to the block configuration or transmit, to the base station, the resource block according to the block configuration.

According to an aspect there is provided an apparatus comprising: means for determining a block configuration for a resource block, wherein the block configuration configures at least one reference signal symbol slot on a pre-defined fixed position in the resource block to convey data via index modulation; means for transmitting, to a user equipment, an indication of the block configuration; and means for transmitting, to the user equipment, a resource block according to the block configuration or means for receiving, from the user equipment, a resource block according to the block configuration.

The apparatus may comprise: means for receiving, from the user equipment, at least one of an indication of whether the user equipment supports a block configuration configuring at least one reference signal symbol on a pre-defined fixed position in the resource block to convey data via index modulation or an indication of at least one parameter determined by the user equipment; and means for determining the block configuration based on the indication.

The apparatus may comprise: means for sending, to the user equipment, a request to send the indication of the at least one parameter.

The apparatus may comprise: means for storing the indication of the at least one parameter.

The apparatus may comprise: means for retrieving an indication of at least one parameter determined by the user equipment for a previous resource block; and means for determining the block configuration based on the at least one parameter.

The at least one parameter may be measured by the user equipment or known from manufacturing by the user equipment.

The at least one parameter may comprise at least one of: a channel characteristics where the resource block is transmitted, a type of radio frequency impairment experienced by the user equipment, a level of radio frequency impairment experienced by the user equipment, conditions of a link used for transmitting the resource block, a user equipment class or a user equipment capability.

The apparatus may comprise: means for determining at least one parameter; and means for determining the block configuration based on the at least one parameter.

The at least one parameter may comprise at least one of: a carrier frequency used for transmitting the resource block, a bandwidth allocated to the user equipment, a modulation and coding scheme used for transmitting the resource block, a variation of a position of the user equipment, an acknowledgment/non-acknowledgement report for a previous resource block or an estimation derived from reference signal symbols of a previous resource block.

The apparatus may comprise: means for receiving, from the user equipment, an indication of a specific block configuration; and means for determining the block configuration based on the specific block configuration.

According to an aspect there is provided an apparatus comprising at least one processor and at least one memory including computer code for one or more programs, the at least one memory and the computer code configured, with the at least one processor, to cause the apparatus at least to: determine a block configuration for a resource block, wherein the block configuration configures at least one reference signal symbol slot on a pre-defined fixed position in the resource block to convey data via index modulation; transmit, to a user equipment, an indication of the block configuration; and transmit, to the user equipment, a resource block according to the block configuration or receive, from the user equipment, a resource block according to the block configuration.

According to an aspect there is provided an apparatus comprising circuitry configured to determine a block configuration for a resource block, wherein the block configuration configures at least one reference signal symbol slot on a pre-defined fixed position in the resource block to convey data via index modulation; transmit, to a user equipment, an indication of the block configuration; and transmit, to the user equipment, a resource block according to the block configuration or receive, from the user equipment, a resource block according to the block configuration.

According to an aspect there is provided a method comprising: determining a block configuration for a resource block, wherein the block configuration configures at least one reference signal symbol slot on a pre-defined fixed position in the resource block to convey data via index modulation; transmitting, to a user equipment, an indication of the block configuration; and transmitting, to the user equipment, a resource block according to the block configuration or receiving, from the user equipment, a resource block according to the block configuration.

According to an aspect there is provided a computer program comprising computer executable code which when run on at least one processor is configured to: determine a block configuration for a resource block, wherein the block configuration configures at least one reference signal symbol slot on a pre-defined fixed position in the resource block to convey data via index modulation; transmit, to a user equipment, an indication of the block configuration; and transmit, to the user equipment, a resource block according to the block configuration or receive, from the user equipment, a resource block according to the block configuration.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AMF: Access and Mobility Management Function
API: Application Programming Interface
APM: Amplitude Phase Module
AWGN: Additive White Gaussian Noise
BER: Bit Error Rate
BPCU: Bit Per Channel Use
BS: Base Station
CFO: Carrier Frequency Offset
CP-OFDM: Cyclic Prefix Orthogonal Frequency Division Multiplexing
CSI-RS: Channel State Information Reference Signal
CU: Centralized Unit
DFT-s-OFDM: Discrete Fourier Transform Spread Orthogonal Frequency Division Multiplexing
DCI: Downlink Control Information
DL: Downlink
DMRS: Demodulation Reference Signal
DU: Distributed Unit
DVB: Digital Video Broadcasting
EE: Energy Efficiency
FSIM: Filter Shapes Index Modulation
gNB: gNodeB
GSM: Global System for Mobile communication
HSS: Home Subscriber Server
IM: Index Modulation
IoT: Internet of Things
LTE: Long Term Evolution
MAC: Medium Access Control
MS: Mobile Station
MSE: Mean Square Error
MTC: Machine Type Communication
NEF: Network Exposure Function
NF: Network Function
NR: New radio
NRF: Network Repository Function
P2P: Peer to Peer
PA: Power Amplifier
PDCCH: Physical Downlink Control Channel
PDSCH: Physical Downlink Shared Channel
PDU: Packet Data Unit
PN: Phase Noise
PRB: Physical Resource Block
PT-RS: Phase Tracking Reference Signal
PUCCH: Physical Uplink Control Channel
PUSCH: Physical Uplink Shared Channel
RAM: Random Access Memory
(R)AN: (Radio) Access Network
RE: Resource Element
ROM: Read Only Memory
SC-FDE: Single Carrier Frequency Domain Equalization
SC-OOK: Single Carrier On-Off Keying
SE: Spectral Efficiency
SMF: Session Management Function
TBS: Transport Block Size
TPC: Transmission Power Command
TR: Technical Report
TS: Technical Specification
UE: User Equipment
UCI: Uplink Control Information
UMTS: Universal Mobile Telecommunication System
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a user equipment;

FIG. 4 shows a schematic representation of a transmission chain of a pure single carrier system;

FIG. 5 shows a schematic representation of a transmission chain of a cyclic prefix orthogonal frequency division multiplexing system;

FIG. 6 shows a schematic representation of a transmission chain of a discrete Fourier transform spread orthogonal frequency division multiplexing system;

FIG. 7 shows a schematic representation of a transmission chain and a receiving chain using index modulation;

FIG. 8 shows a schematic representation of a cyclic prefix orthogonal frequency division multiplexing system resource block for a physical uplink shared channel;

FIG. 9 shows a schematic representation of a discrete Fourier transform spread orthogonal frequency division multiplexing system resource block for a physical uplink shared channel;

FIG. 10 shows table 5.1.6.3-1 (Time density of phase tracking reference signal as a function of scheduled modulation and coding scheme) and table 5.1.6.3-2 (Frequency density of phase tracking reference signal as a function of scheduled bandwidth) of 3GPP TS 38.214 for a cyclic prefix orthogonal frequency division modulation system;

FIG. 11 shows table 6.2.3.2-1 phase tracking reference signal group pattern as a function of scheduled bandwidth of 3GPP TS 38.214 for a discrete Fourier transform spread orthogonal frequency division multiplexing system;

FIG. 12 shows an illustration of various block configurations for data and reference signal transmission;

FIG. 13 shows a table comprising various block configurations for data and reference signal transmission;

FIG. 14 shows a block diagram of a method for determining a block configuration for data and reference signal transmission and the resulting technical advantages;

FIG. 15 shows another block diagram of a method for determining a block configuration for data and reference signal transmission;

FIG. 16 shows signal diagrams of a process for transmitting and receiving a reference signal and data over any physical channel;

FIG. 17 shows a block diagram of a method for receiving a reference signal and data performed by an apparatus, for example a user equipment;

FIG. 18 shows a block diagram of a method for transmitting a reference signal and data performed by an apparatus, for example a base station; and

FIG. 19 shows a schematic representation of a non-volatile memory medium 2100 storing instructions which when executed by a processor allow a processor to perform one or more of the steps of the methods of FIGS. 17 and 18.

### DETAILED DESCRIPTION OF THE FIGURES

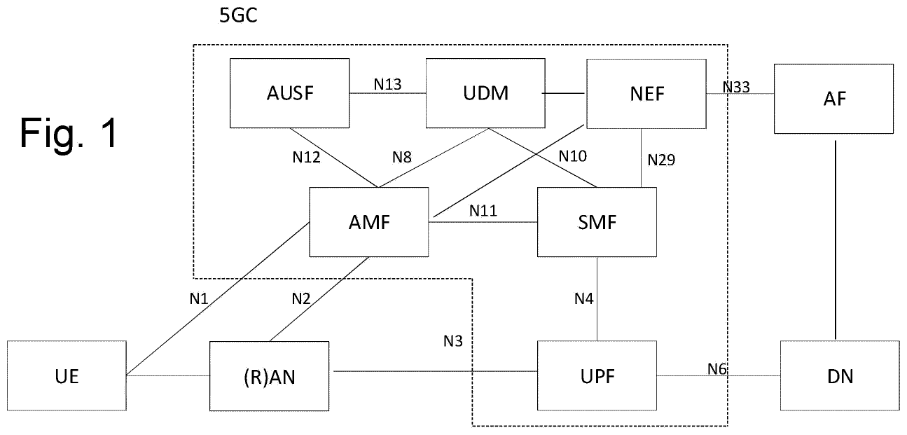

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a user equipment (UE), a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise at least one of an access and mobility management function (AMF), a session management function (SMF), an authentication server function (AUSF), a user data management (UDM), a user plane function (UPF) or a network exposure function (NEF).

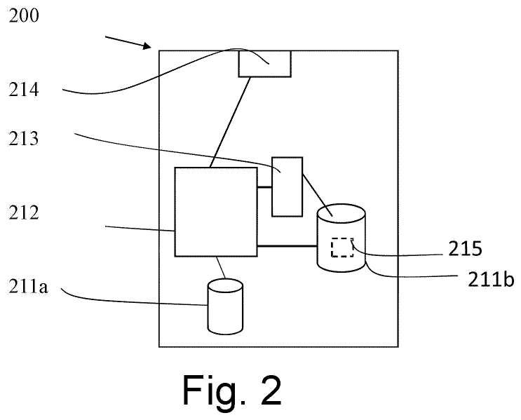

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

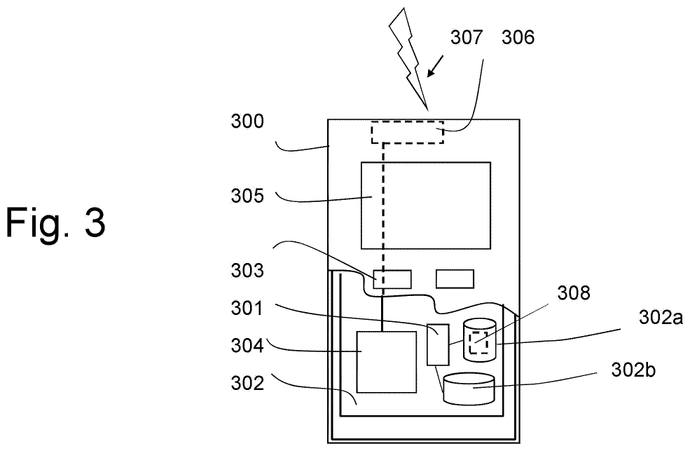

FIG. 3 illustrates an example of a UE 300, such as the UE illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on at least one of an appropriate circuit board or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more aspects of this disclosure relates to at least one of receiving or sending a reference signal (RSs) and data in a communication system, in particular using a single-carrier waveform.

In NR Release 18 workshop and in the following email discussion prior to RAN#93-e it has been discussed using a single-carrier waveform both in uplink (UL) and downlink (DL) and operating in sub-THz frequency bands. This was eventually not implemented in NR Release 18 and was postponed to NR Release 19 or beyond.

A single-carrier waveform may be provided by a discrete Fourier transform (with or without known tail) spread orthogonal frequency division multiplexing ((KT) DFT-s-OFDM) system, a single carrier frequency domain equalization (SC-FDE) system or a single carrier time domain equalization (SC-TDE). In DFT-s-OFDM, each DFT-s-OFDM symbol may be prepended with cyclic prefix, while in KT-DFT-s-OFDM (also known as unique word DFT-s-OFDM), there may be no cyclic prefix, but there may be a known sequence(s) of pre-defined length(s) inserted in at least one of the beginning (head) or end (tail) of each symbol, prior to the DFT operation at the transmitter. By contrast, a multiple-carrier waveform may be provided by a cyclic prefix orthogonal frequency division multiplexing (CP-OFDM) system.

A legacy 5GS uses a multiple-carrier waveform provided by a CP-OFDM system on the DL and a multiple-carrier waveform provided by a CP-OFDM system or a single-carrier waveform provided by a DFT-s-OFDM on the UL.

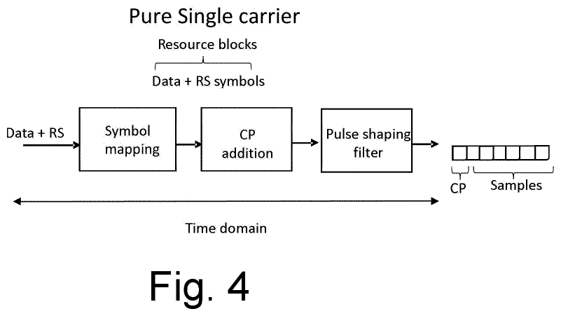

FIG. 4 shows a schematic representation of a transmission chain of a pure single carrier (e.g. SC-FDE) system. The operation of a pure single carrier system is well known and therefore not described in details.

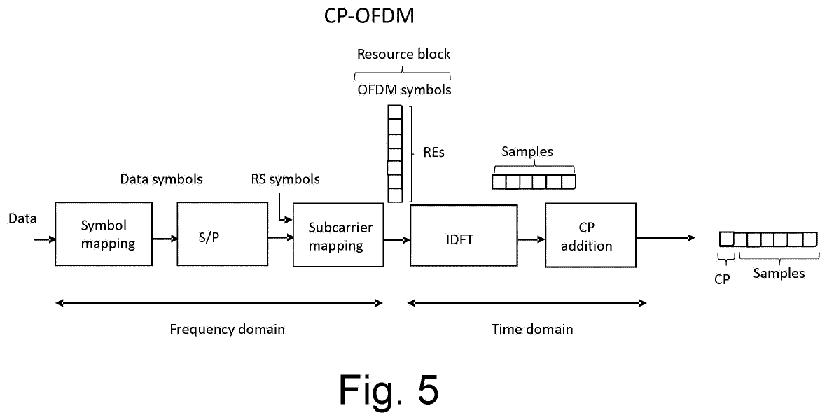

FIG. 5 shows a schematic representation of a transmission chain of a CP-OFDM system. The operation of a CP-OFDM system is well known and therefore not described in details.

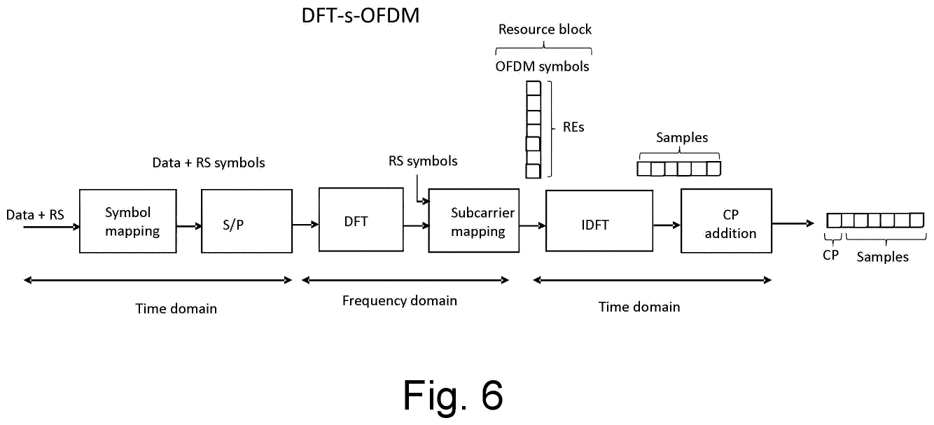

FIG. 6 shows a schematic representation of a transmission chain of a DFT-s-OFDM system. The operation of a DFT-s-OFDM system is well known and therefore not described in details.

It will be understood that in FIGS. 4, 5 and 6 the prefix part could be other than CP (e.g. unique word, known tail, zero padding or guard interval, special purpose part, etc).

A single-carrier waveform may achieve a higher equivalent isotropic radiated power (EIRP) (e.g. 60 dBm) with a smaller power amplifier output power backoff (OBO) than a multiple-carrier waveform. Thus, a single-carrier waveform may reduce cost and complexity of the hardware as well as power consumption compared to a multiple-carrier waveform. Moreover, a single-carrier waveform may be more robust to phase noise (PN) with lower complexity than a multiple-carrier waveform.

The frequency spectrum comprising sub-THz frequency bands is large but comprise various usage restrictions, such as RR5.340 where all communications are prohibited (passive satellite band). The sub-THz frequency bands include a W-band (75 to 110 GHZ), a D-band (110 to 170 GHZ) and other bands up to THz frequencies (see S. Bicaïs, J-B. Doré, M. Saad, M. Alawieh, F. Bader, J. Palicot, Y. Corre, G. Gougeon, and E. Faussurier, Wireless Connectivity in the Sub-THz Spectrum: A Path to 6G, November 2021).

European telecommunications regulator European Conference of Postal and Telecommunications (CEPT) Electronics Communication Committee (ECC) has approved two recommendations for fixed service (FS) above 92 GHz:
W Band ECC Recommendation ECC/REC/(18)02 on frequencies 92-114.25 GHZ (link); and
D Band ECC Recommendation ECC/REC/(18)01 on frequencies 130-174.8 GHZ (link).

These frequency bands may be the next frontier after FR2-1 and FR2-2. However, these frequency bands may suffer from more technological limitations, severe RF impairments, especially for low-cost devices, and also at least one of higher attenuations, blockages or absorptions in the environment. These frequency bands may be associated with various challenges.

A challenge may be a low transmit output power at the edge of electronics technology. The output power is lower at sub-THz (near the maximum operating frequencies of non-optical sources) due to low efficiency of hardware components mainly power amplifier and power sources (see G. Chattopadhyay, “Technology, capabilities, and performance of low power terahertz sources,” IEEE Transactions on Terahertz Science and Technology, vol. 1, no. 1, pp. 33-53, September 2011).

Another challenge may be a high phase noise (PN) with a stronger uncorrelated component in wideband. The PN may change significantly from symbol to symbol and the PN tracking algorithms may be less efficient with uncorrelated PN (see S. Bicais and J.-B. Dore, “Phase Noise Model Selection for Sub-THz Communications,” 2019 IEEE Global Communications Conference (GLOBECOM), 2019, pp. 1-6, doi: 10.1109/GLOBECOM38437.2019.9013189).

Another challenge may be a medium to high carrier frequency offset (CFO) due to hardware imprecisions, drift and mobility.

Another challenge may be a high doppler spread (i.e. shift) even with small mobility at high frequencies.

Another challenge may be a high sampling rate requirements for analogue to digital converters and digital to analogue converters. The power consumption may increase exponentially with the sampling rate.

Another challenge may be a limited resolution (few bits quantization) being preferred for power-efficient low-cost analogue to digital converters and digital to analogue converters to compensate the exponential increase of the power consumption with the high sampling rate due to larger bandwidth.

Another challenge may be more non-linearities in the power amplifier (PA) and hardware components at higher frequencies.

These challenges may lead to more noisy and distorted reference signals (low signal power with limited transmit power and high attenuations in sub-THz, low quantization leading to higher quantization noise, more distortions leading to lower SNIR). Thus, more reference signals may be needed to enhance at least one of the following: estimation accuracy, estimation frequency, coverage or energy efficiency

It is clear that higher energy efficiency to reduce the power consumption, smaller peak to average power ratio to achieve at least one of higher transmit power or higher robustness to radio frequency (RF) impairments may be core design requirements for a communication system at these frequency bands and even at lower frequencies for more energy efficient system. In addition, the communication system may need to better estimate and track the fast-time varying parameters (uncorrelated PN, channels with high doppler, etc.).

Based on the above challenges, one aspect will be to consider single-carrier waveforms both in uplink and downlink. It allows to reach a higher effective isotropic radiated power (e.g. 60 dBm) with smaller power amplifier (PA) output power backoff to achieve higher signal to noise ratio. This may be crucial with the limited transmit power in current technology maturity and the high attenuations. Briefly, some single carrier waveform systems, such as pure single carrier (e.g. SC-FDE) systems, are more power efficient with smaller peak to average power ration, more robust to PN and RF impairments, and less sensitive to coarse ADC quantization than other single carrier systems, such as DFT-s-OFDM systems, or multicarrier waveform systems, such as CP-OFDM (see L. H. Nguyen, V. Braun, H. Halbauer and T. Wild, “Waveform Comparison under Hardware Limitations for 6G Sub-THz Communications,” 2022 IEEE 19th Annual Consumer Communications & Networking Conference (CCNC), 2022, pp. 1-6, doi: 10.1109/CCNC49033.2022.9700588 and Majed Saad. Back to Single-Carrier for Beyond-5G Communications above 90 GHz: Novel Index Modulation techniques for low-power Wireless Terabits system in sub-THz bands. Signal and Image processing. CentraleSupélec, 2020).

PN may originate mainly from local oscillators in the up and down conversion. Usually in OFDM based systems (including DFT-s-OFDM) the PN may impact in a form of common phase error (CPE) which is common for all subcarriers and inter carrier interference (ICI) which is basically unique for each carrier. The impact may depend especially on the subcarrier spacing. PN and inter carrier interference compensation may be required to enable the communication with these waveforms.

The PN spectrum may typically depend on the used oscillators. The PN effect may depends on the signal bandwidth (or symbol rate). The PN may be modelled as a combination of correlated component (e.g. Wiener type of PN) and uncorrelated component (i.e. white gaussian type of PN floor). The threshold for the dominant parameter can be approximated based on the condition (1) below (see S. Bicais and J.-B. Dore, “Phase Noise Model Selection for Sub-THz Communications,” 2019 IEEE Global Communications Conference (GLOBECOM), 2019, pp. 1-6, doi: 10.1109/GLOBECOM38437.2019.9013189).

$$N \cdot {f}_{c}^{2} \cdot {T}^{2} \leq \frac{ln ( 2 )}{2 {π}^{2}} \qquad ( 1 )$$

N may be the number of symbols per frame.
fc may be an oscillator corner frequency.
T may be a symbol period (i.e. inverse of system bandwidth).

If the condition (2) below is met, the dominant component may be the uncorrelated component. That is, the uncorrelated component may be greater than the correlated component.

$$N \cdot {f}_{c}^{2} \cdot {T}^{2} < \frac{ln ( 2 )}{2 {π}^{2}} \qquad ( 2 )$$

This may be the case with larger bandwidth (smaller symbol period T). Hence, the compensation of the correlated component has nearly no effect in the performance in such case (see M. R. Khanzadi, D. Kuylenstierna, A. Panahi, T. Eriksson, and H. Zirath, “Calculation of the performance of communication systems from measured oscillator phase noise,” IEEE Transactions on Circuits and Systems I: Regular Papers, vol. 61, no. 5, pp. 1553-1565 May 2014). The uncorrelated component may be estimated and compensated. As a result, more RS may be required since the uncorrelated component cannot be tracked (uncorrelated random phase variation).

If the condition (3) below is met, the dominant component may be the correlated component. That is, the correlated component may be greater than the uncorrelated component.

$$N \cdot {f}_{c}^{2} \cdot {T}^{2} > \frac{ln ( 2 )}{2 {π}^{2}} \qquad ( 3 )$$

If the condition below (4) is met, there may be no dominant component. That is, the correlated component may be substantially equal to the uncorrelated component.

$$N \cdot {f}_{c}^{2} \cdot {T}^{2} \approx \frac{ln ( 2 )}{2 {π}^{2}} \qquad ( 4 )$$

Index modulation (IM) may be used to convey information bits by changing the state of a communication system represented by an index. Compared to traditional techniques using amplitude, phase or frequencies to convey information. The state of a communication system may be controllable at the transmitter and detectable at the receiver.

IM may be implemented in various manners (see T. Mao, Q. Wang, Z. Wang and S. Chen, “Novel Index Modulation Techniques: A Survey,” in IEEE Communications Surveys & Tutorials, vol. 21, no. 1, pp. 315-348, Firstquarter 2019, doi: 10.1109/COMST.2018.2858567).

IM may be implemented by activating or targeting transmit/receive antenna(s) (spatial IM), where the activated/targeted antenna(s) are indexed to convey additional information.

IM may be implemented by activating time slot(s) or subcarrier(s) from a group of reserved sets where the activated time slot(s) or subcarrier(s) are indexed to convey additional information (time IM and frequency IM).

A general block diagram for IM may comprise a data bitstream divided into two data sub-streams (see Mao, Q. Wang, Z. Wang and S. Chen, “Novel Index Modulation Techniques: A Survey,” in IEEE Communications Surveys & Tutorials, vol. 21, no. 1, pp. 315-348, First quarter 2019, doi: 10.1109/COMST.2018.2858567). A first sub-stream may be mapped to conventional M-ary amplitude phase modulation (APM) data symbols (e.g., QAM, PSK, etc.). A second sub-stream may be mapped to an index that select a state of the communication system among a finite set of states. This index may allow to convey additional information. Note that the state of the communication system should be detectable at the receiver side to recover the additional information whilst allowing the detection of the APM symbols.

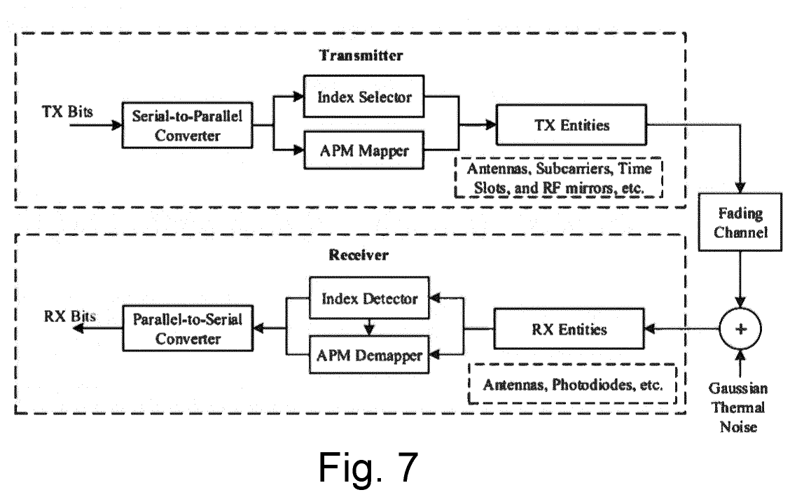

FIG. 7 shows a schematic representation of a transmission chain and a receiving chain using index modulation (see Mao, Q. Wang, Z. Wang and S. Chen, “Novel Index Modulation Techniques: A Survey,” in IEEE Communications Surveys & Tutorials, vol. 21, no. 1, pp. 315-348, First quarter 2019, doi: 10.1109/COMST.2018.2858567).

A promising scheme for single carrier (e.g. SC-FDE) that uses simultaneously all time slots, frequency resources and spatial resources (if any) in contrast to time IM, frequency IM and spatial IM is filter shapes index modulation (FSIM) (see M. Saad, J. Palicot, F. Bader, A. C. A. Ghouwayel and H. Hijazi, “A Novel Index Modulation Dimension Based on Filter Domain: Filter Shapes Index Modulation,” in IEEE Transactions on Communications, vol. 69, no. 3, pp. 1445-1461 March 2021, doi: 10.1109/TCOMM.2020.3039842). This scheme may transmit APM symbols on all time slots and may conveys additional information through the index of a pulse shaping filter selected from a bank of N pulse shaping filters. The index of the pulse shaping filter may change at symbol rate. Hence, it may allow to achieve a spectral efficiency (SE) of log₂ M+log₂ N bits per channel use (bpcu), where FSIM with N filters transmitting M-ary APM symbols is denoted by N-FSIM-MAPM. The channel use (bandwidth occupation) may be the same as conventional systems (e.g. QAM with Root raised cosine filters). The results reveal that FSIM even with non-optimal filters outperforms the equivalent QAM systems of the same SE in additive white gaussian noise (AWGN), flat and frequency selective fading channels. For example, 2-FSIM-4QAM (3bpcu) outperforms 8QAM (3bpcu) by 3.5 dB in AWGN.

As discussed above the sub-THz frequency bands introduces various challenges for establishing reliable communications.

A challenge may be low signal to noise ratio and poor coverage due to low output power at high frequencies and high attenuations. Power amplifiers working at very high frequencies may have very low efficiencies at the edge of electronics technology. With high peak to average power ratio signals, further losses may be caused by the required backoff, leading to low power output and resulting in low signal to noise ratio and poor coverage. Low peak to average power ratio signals may be required to limit backoff and increase power amplifier output power and efficiency. The 6G communication system physical layer should be designed from the ground up with peak to average power ratio constraints in mind, and this argument is in favour of single carrier (e.g. SC-FDE), especially for sub-THz.

Another challenge may be strong uncorrelated component generated by local oscillators being dominant in wide bandwidth. High frequency oscillators working in the sub-THz frequency bands are plagued by strong phase noise. When the system bandwidth is large compared to the oscillator corner frequency, the uncorrelated component may become dominant. Frequent PN estimation may be performed in order to suppress the effect of the uncorrelated component. Current systems may not perform frequent PN estimation without highly sacrificing the spectral efficiency. Currently, phase tracking reference signal (PT-RS) symbols for PN estimation may be allocated to resource elements (REs) in 5G-NR. Placed at regular intervals in time, it may be possible to interpolate the PN on adjacent data symbols to reduce the time density of the PT-RS symbols when the PN is more correlated. In sub-THz frequency bands with wider bandwidth, the uncorrelated component may be higher and dominant. Thus, more frequent and ultimately independent PN estimation per each equivalent OFDM symbol period with any waveform and per each modulation symbol or RE with single carrier may need to be performed without interpolation over time. In high PN, PT-RS may require a higher time density at equivalent OFDM symbol level and even with a finer granularity at modulation symbol or RE level, coming at the cost of SE. This high time density requirement may also be needed with low modulation and coding scheme (MCS) in sub-THz frequency and FR2 bands, because modulation symbols without PT-RS cannot eliminate the dominant uncorrelated component and the cancellation of the correlated component only as in 5G has almost no impact on the performance (see M. R. Khanzadi, D. Kuylenstierna, A. Panahi, T. Eriksson, and H. Zirath, “Calculation of the performance of communication systems from measured oscillator phase noise,” IEEE Transactions on Circuits and Systems I: Regular Papers, vol. 61, no. 5, pp. 1553-1565 May 2014).

Another challenger may be high Doppler spread in case of mobility. This may lead to small channel coherence time and may require regular channel estimation. In addition, a low signal to noise ratio may require more RS for better accuracy. Currently, demodulation reference symbols (DMRS) symbols for channel estimation may be allocated to some REs and the maximum DMRS allocation per slot may not be sufficient in poor coverage. In order to enhance the channel estimation accuracy in Rel-17 CovEnh, DMRS bundling and joint channel estimation are proposed with the assumption of (quasi)-static channel over multiple slots. DMRS bundling and joint estimation over multiple slots may be no more beneficial with very high doppler spread since these DMRS on the different slots could be subjected to different channels in this case. Note the high doppler may be achieved even with small mobility at these high frequencies. In order to enhance channel estimation accuracy with a time varying channel, more RS per slot may be required, especially at low SNR.

In summary, communication systems operating especially in the FR2 and sub-THz frequency bands may need to perform frequent and accurate channel and RF impairments estimations especially at low SNR with an acceptable RS overhead to enhance the coverage.

RS symbols are occupying specific fixed pre-defined REs known for the transmitter and receiver. When transmitting RSs over a communication system, Rel-17 does not allow for data to be transmitted with RS over a same RE, as depicted in 3GPP TS 38.211 V17.1.0, section 6.1.2. Thus, the requirement for more RSs to estimate the fast time varying parameters has inevitable overhead and SE degradation.

Various RSs are being used in 5G. DM-RS is a pilot signal used for channel estimation. PT-RS is used to estimate phase noise. Channel state information reference signal (CSI-RS) and sounding reference signal (SRS) report channel state information in the downlink and in the uplink respectively.

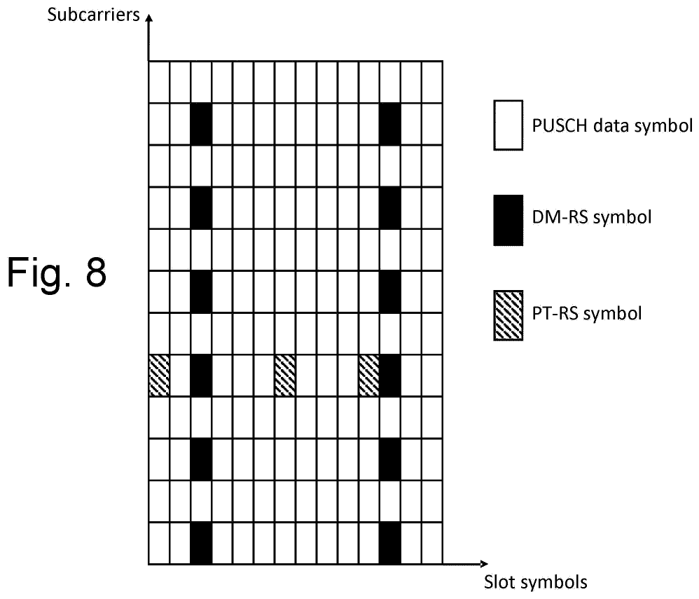

FIG. 8 shows a schematic representation of a CP-OFDM system resource block for a physical uplink shared channel (PUSCH). OFDM symbols with DMRS or PT-RS allocated may still transmit data through different subcarriers

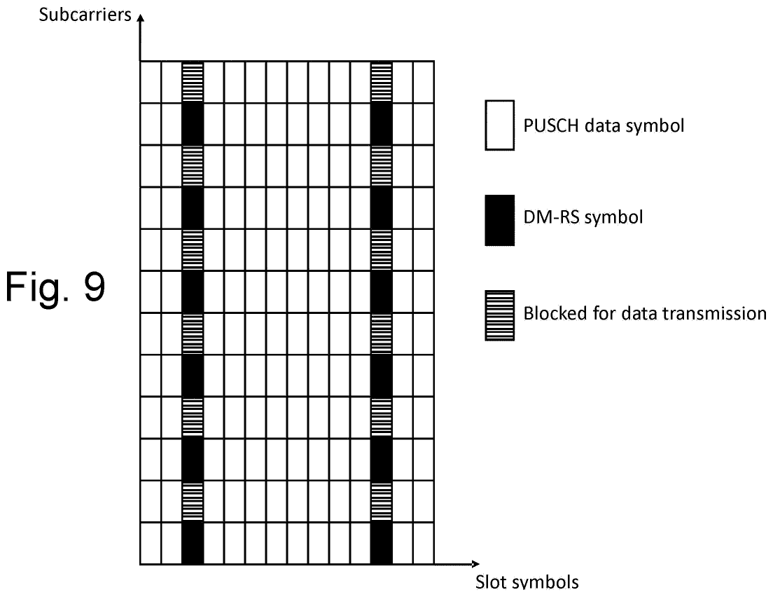

FIG. 9 shows a schematic representation of a DFT-s-OFDM system resource block for a PUSCH. DFT-s-OFDM symbols with DMRS allocated may not transmit data through different subcarriers

For both the CP-OFDM system resource block and the DFT-s-OFDM system resource block, DMRS may be frequency multiplexed. DMRS configuration may provide higher frequency density to consider the frequency selectivity of the channel. PT-RS may be time multiplexed. PT-RS configuration may provide higher time density at equivalent OFDM symbol level to consider the time variation of PN which is common for all subcarriers (CPE).

PT-RS may be critical for higher frequency bands with high uncorrelated or correlated component (e.g. FR2 and sub-THz).

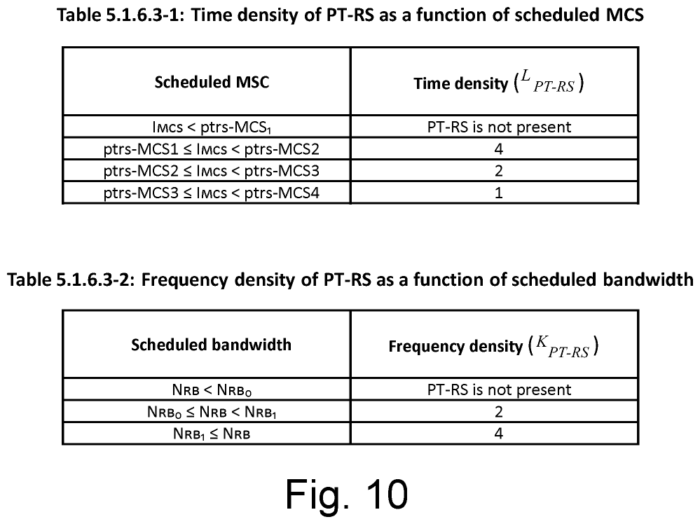

3GPP TS 38.214 defines, as illustrated in FIG. 10, PT-RS time density (in OFDM symbol-level) based on MCS (configurable) and PT-RS frequency density (RE in each OFDM symbol) based on resource block (RB) allocation thresholds (configurable) for CP-OFDM systems.

FIG. 10 shows table 5.1.6.3-1 (Time density of PT-RS as a function of scheduled MCS) and table 5.1.6.3-2 (Frequency density of PT-RS as a function of scheduled bandwidth) of 3GPP TS 38.214 for a CP-OFDM system.

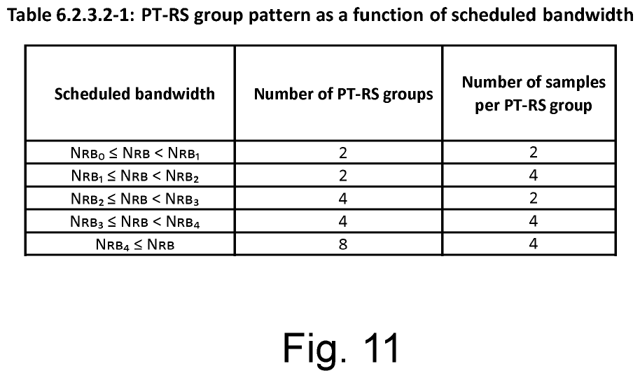

3GPP TS 38.214 further defines, as illustrated in FIG. 11, PT-RS group pattern within each DFT-s-OFDM symbol based on RB allocation thresholds (configurable) for DFT-s-OFDM.

FIG. 11 shows table 6.2.3.2-1 PT-RS group pattern as a function of scheduled bandwidth of 3GPP TS 38.214.

‘sampleDensity’ and ‘timeDensity-TransformPrecoding’ are additional configurable parameters that allow to define PT-RS group pattern within a DFT-s-OFDM symbol using the table and within a slot in OFDM symbol level respectively.

‘sampleDensity’ parameter configures the thresholds (NRB0 to NRB4) that indicates which PTRS group pattern row to select according to this Table 6.2.3.2-1 and allocated BW in NRB. Regardless which PTRS group pattern is selected, PT-RS time domain density (in OFDM symbol-level) (configurable) ‘timeDensity-TransformPrecoding’ could be specified for DFT-s-OFDM to indicate if every DFT-s-OFDM symbol period would contain the selected PTRS group pattern, every other DFT-s-OFDM symbol, etc.

3GPP TS 38.331 reads as follows.
“PTRS-UplinkConfig
The IE PTRS-UplinkConfig is used to configure uplink Phase-Tracking-Reference-Signals (PTRS).

PTRS-UplinkConfig information element

```
-- ASN1START
-- TAG-PTRS-UPLINKCONFIG-START
PTRS-UplinkConfig ::= SEQUENCE {
    transformPrecoderDisabled SEQUENCE {
        frequencyDensity SEQUENCE (SIZE (2)) OF INTEGER (1..276)
      OPTIONAL, -- Need S
        timeDensity SEQUENCE (SIZE (3)) OF INTEGER (0..29) OPTIONAL,
      -- Need S
        maxNrofPorts ENUMERATED {n1, n2},
        resourceElementOffset ENUMERATED {offset01, offset10, offset11 }
      OPTIONAL, -- Need S
        ptrs-Power ENUMERATED {p00, p01, p10, p11}
  } OPTIONAL, -- Need R
    transformPrecoderEnabled SEQUENCE {
        sampleDensity SEQUENCE (SIZE (5)) OF INTEGER (1..276),
        timeDensityTransformPrecoding ENUMERATED {d2} OPTIONAL --
      Need S
    } OPTIONAL, -- Need R
    ...
}
-- TAG-PTRS-UPLINKCONFIG-STOP
-- ASN1STOP”
```

3GPP TS 38.331 further reads as follows.

sampleDensity

“Sample density of PT-RS for DFT-s-OFDM, pre-DFT, indicating a set of thresholds T={NRBn, n=0,1,2,3,4}, that indicates dependency between presence of PT-RS and scheduled BW and the values of X and K the UE should use depending on the scheduled BW, see TS 38.214, clause 6.1, table 6.2.3.2-1”.

“timeDensityTransformPrecoding

Time density (OFDM symbol level) of PT-RS for DFT-s-OFDM. If the field is absent, the UE applies value d1 (see TS 38.214, clause 6.1)”.

PT-RS uplink configuration parameters are defined in 3GPP TS 38.331. When ‘timeDensity’ is absent for CP-OFDM, the UE may assume a time density of 1 at OFDM symbol level. When ‘timeDensityTransformPrecoding’ is absent for DFT-s-OFDM, the UE may assume a time density of 1 at equivalent OFDM symbol level.

PT-RS with CP-OFDM and DFT-s-OFDM can have a high coarse time density at equivalent OFDM symbol level (Lptrs=1 or timeDensityTransformPrecoding=1, i.e. PT-RS on each equivalent OFDM symbol). But it is clear from FIG. 11 for single carrier (e.g. DFT-s-OFDM) that the maximum number of PT-RS samples in time domain within one DFT-s-OFDM symbol is 32 distributed over 8 PT-RS groups with 4 samples each. This PT-RS fine time granularity could be not sufficient to estimate accurate and frequent enough the PN especially the uncorrelated type. Hence, more PT-RS with a finer granularity at sample level or modulation symbol level or resource element level with single carrier would be needed for high PN.

In Rel-17 coverage enhancement work items, different techniques are proposed to enhance the channel estimation such as DMRS bundling and joint channel estimation over different slots in transport block over at least one of multiple slots or PUSCH repetitions. This technique may allow to acquire more DMRS to enhance the estimation accuracy in the assumption of static channel or slow-time varying channels in extreme cases. However, the advantage of these techniques is not fully maintained or even lost in fast-time varying channels. Thus, DMRS bundling over a long period could no longer be possible.

Increasing the number of RS symbols within the same slot may be imposed to enhance the estimations especially at low signal to noise ratio which is common in low coverage scenario as in sub-THz frequency bands. This option may reduce significantly the SE since the standard does not allow for data transmission in RS.

It is worth mentioning that the RS symbols with single carrier waveform (e.g. SC-FDE) may be all time multiplexed and thus a modulation symbol or resource element is either carrying data or a RS over all allocated BW as it is currently supported in digital video broadcasting (DVB) standards (see ETSI EN 302 307 V1.2.1; Digital Video Broadcasting (DVB); Second generation framing structure, channel coding an demodulation systems for Broadcasting, Interactive Services, News Gathering and other broadband satellite applications (DVB-S2)) and institute of electronics and electrical engineers (IEEE) standards (e.g. IEEE 802.15.3d—see “IEEE Standard for High Data Rate Wireless Multi-Media Networks—Amendment 2:100 Gb/s Wireless Switched Point-to-Point Physical Layer,” in IEEE Std 802.15.3d-2017 (Amendment to IEEE Std 802.15.3-2016 as amended by IEEE Std 802.15.3e-2017), vol., no., pp. 1-55, 18 Oct. 2017, doi: 10.1109/IEEESTD.2017.8066476). Here, it must be understood that ‘or’ is an ‘exclusive or’, that is the modulation symbol or resource element is not carrying data and a RS.

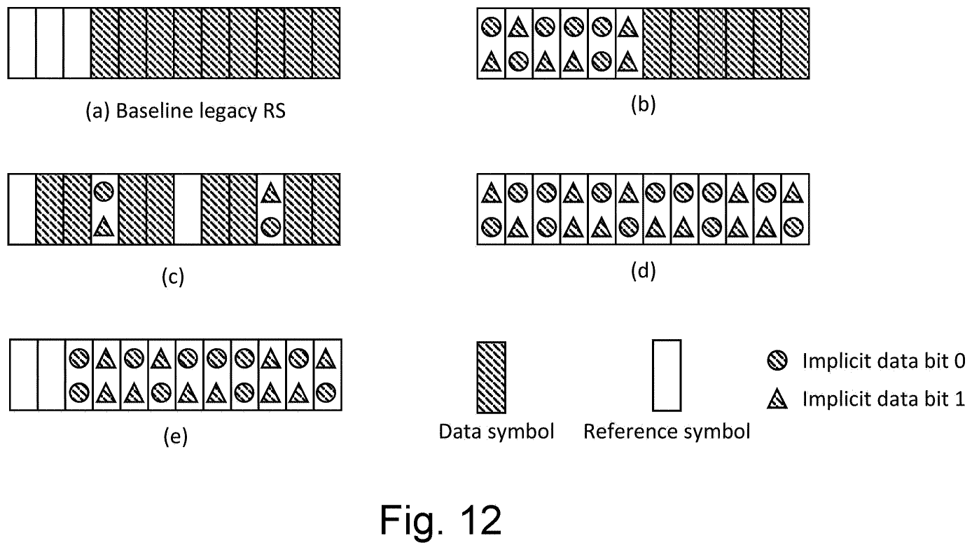

FIG. 12(a) shows a resource block with legacy RS configuration using single carrier or multicarrier system. As can be seen, 3 out of 12 symbols in a block may be RS symbols. This leads to a 25% RS overhead in this block and possibly unsatisfactory estimations accuracy especially in the sub-THz frequency bands (low fine time-density with single carrier and small number of RS).

Channel and RF impairments in higher frequency ranges require more RS symbols. Considering the example block again of FIG. 12(a), using 6 RS symbols translates into a 50% RS overhead in this block. This strong loss in SE cannot be compensated by raising modulation order on the data symbols, as the system becomes more vulnerable to phase noise and is suffering from low signal to noise ratio. Furthermore, the coarse time-density at equivalent OFDM symbol level can be equal to one in the current standard with CP-OFDM and DFT-s-OFDM. This is no longer possible with any waveform (e.g. SC-FDE, CP-OFDM or DFT-s-OFDM) using also a finer time density at modulation symbol level or sample level or RE level equal to one since no data can be transmitted with 100% samples fully allocated for RS.

All in all, RS symbols create a compromise between SE and estimation quality. Using a higher number of RS symbols for estimation results in a lower number of data symbols. Higher frequency bands will require more frequent estimates, accentuating this issue.

Current systems cannot offer frequent estimations without greatly sacrificing SE. In addition, the SE will dramatically decrease in case of single carrier because all RS symbols are time multiplexed and each single carrier modulation symbol occupies all reserved bandwidth. Thus, the finer time density at modulation symbol level (equivalent to CP-OFDM sample level in time) equal to one may be not possible at all with SC-FDE and any waveform because a block with all RS symbols means no data symbols and zero SE.

Therefore, the RS symbol design and allocation may be studied at higher frequencies especially if finer granularity and higher density is needed with any waveform, or single carrier waveform (e.g. SC-FDE) is considered with all RS symbols (DMRS and PTRS, . . . ) multiplexed in time domain on fully dedicated symbol occupying all allocated bandwidth.

One or more aspects of this disclosure tackle one or more of the above challenges.

One or more aspects of this disclosure provide RS symbols on pre-defined fixed positions known by the transmitter and the receiver. These pre-defined fixed positions may be configurable.

One or more aspects of this disclosure may allow finer density for RS at modulation symbol level or RE level or sample level equal to one (i.e., all REs carry RS) while transmitting data.

One or more aspects of this disclosure may reduce/avoid the high RS overhead and impact on SE.

One or more aspects of this disclosure may allow the estimation of uncorrelated and correlated type of PN at least more frequently or accurately while transmitting data.

One or more aspects of this disclosure may enhance the estimation accuracy for channel or PN by providing more DMRS or PTRS symbols within the same block while maintaining at least the same SE.

One or more aspects of this disclosure may provide a flexible reconfigurable method to adapt with channel conditions and RF impairments.

One or more aspects of this disclosure may provide a better trade-off between the SE and estimation accuracy especially at low signal to noise ratio.

One or more aspects of this disclosure may allow using lower coding rate for better coverage while maintaining at least same number of RS symbols and same SE.

One or more aspects of this disclosure may allow adding more RS for better coverage to PDCCH or PUCCH without reducing DCI or UCI size as the straightforward addition of legacy RS would do (e.g. RS could be PTRS to compensate PN since these channel are currently without PTRS in Rel-17 and high PN would limit their coverage).

One or more aspects of this disclosure may allow more efficient UCI multiplexing on PUSCH by implicitly conveying UCI bits also within RS REs (e.g. DMRS, PTRS, . . . ) of PUSCH in contrast to current UCI multiplexing in rel-17 specifications.

In order to reduce the effect of PN and improve channel capacity, 3GPP TS 38.211 describes RSs used for phase noise/channel estimation. 5G allows different number of RSs and patterns, frequency density for CP-OFDM and coarse time density at OFDM symbol level for CP-OFDM and DFT-s-OFDM to adapt with channel and PN conditions as discussed above.

However, there is no prior arts in 5G with single carrier other than DFT-s-OFDM, and the prior arts from other standards using SC-FDE in DVB (see ETSI EN 302 307 V1.2.1; Digital Video Broadcasting (DVB); Second generation framing structure, channel coding a demodulation systems for Broadcasting, Interactive Services, News Gathering and other broadband satellite applications (DVB-S2)) are more for low frequencies where these aforementioned sub-THz problems are not significant.

However, the first standardization efforts in IEEE 802.15.3d consider the sub-THz bands. This standard defines a frame structure with sufficiently long RS sequence length and different MCS with SC-FDE to adapt with the channel and transceiver/environment conditions. In addition, it introduces single carrier on-off keying (SC-OOK) as an option for extreme cases when PN is very high and cannot be compensated in peer to peer (P2P) devices (e.g. data center, . . . ) because OOK is robust to PN. However, SC-OOK highly degrades the system SE, and the throughput gain targeted by wider bandwidth in sub-THz is sacrificed by such low spectral efficient APM (OOK is theoretically 1 bit per channel use, but its SE in bps/Hz could be much lower due to the abrupt time change and larger BW occupation). In addition, it is worth mentioning that low cost UEs will suffer often from high PN, and thus a better solution is required.

Recently, index modulation was applied to pilot or RS insertion with OFDM system (see Q. Li, M. Wen, Y. Zhang, J. Li, F. Chen and F. Ji, “Pilot Insertion with Index Modulation for OFDM-Based Vehicular Communications,” 2018 IEEE Global Conference on Signal and Information Processing (GlobalSIP), 2018, pp. 1204-1208, doi: 10.1109/GlobalSIP.2018.8646384) for vehicular communications and SC-FDE (T. Mao and Z. Wang, “Terahertz Wireless Communications With Flexible Index Modulation Aided Pilot Design,” in IEEE Journal on Selected Areas in Communications, vol. 39, no. 6, pp. 1651-1662 June 2021, doi: 10.1109/JSAC.2021.3071841) for sub-THz systems. Their motivation is mainly to reduce the effect of RS overhead and enhance the overall SE only.

The former system with OFDM for vehicular communications allows flexible RS/pilots positions (not fixed and unknown RS positions for the receiver) in which the pilot positions are selected according to extra information bits (additional bits are conveyed by means of pilot position IM after the detection of pilot positions). This system for vehicular communications requires to correctly detect the pilot positions in order to perform channel estimation, and then to proceed to data detection. However, the former technique based on pilot position IM with OFDM developed for vehicular communications shows the results in perfect CSI assumption without considering the channel estimation degradation due to unknown pilot positions. The correct detection of pilot positions may be crucial to perform firstly the channel estimation and then to deduce the additional bits conveyed by IM. The pilots position detection accuracy prior to channel equalization may be questionable. Even with the perfect CSI assumption, the results of these systems with OFDM at SE~2bps/Hz may be worse than classical OFDM with fixed RS at low SNR region.

The systems for SC-FDE with pilot position indexation may be quite similar in the indexation of RS position to convey additional bits. The study with SC-FDE systems may be more realistic by considering CSI estimation on quasi-static case (slow time varying channel) where the previous CSI in previous slots can be used for pre-estimation of pilot positions in the first iteration, and then an iterative approach in a turbo receiver may be used to enhance the performance. In order to have better performance, it may not be possible to have an overall bit error rate (BER) lower than 0.2 when pilots and data have the same power. Power boosting for all RS may be required to be in order of four times higher than data to allow the RS or pilot position detection and better channel estimation. However, the channel estimation accuracy may be limited using this pilot position IM where the theoretical lower bound of channel estimation means square error (MSE) with large number of iterations may be around 4.10⁻² at high signal to noise ratio

FIG. 12 shows various block configurations. The x-axis and γ-axis could be time and frequency respectively for time domain RS or vice versa for frequency domain RS.

The circle and triangle in the legend represent the data bits conveyed implicitly within same allocation of RS symbol or resource element (we can have 1 or more bits).

In a first block configuration FIG. 12(a)), the block may comprise RS symbols and data symbols. RS symbols do not convey data through IM.

In a second block configuration (FIG. 12(b)), the block may comprise RS symbols and data symbols. All RS symbols convey data through IM.

In a third block configuration (FIG. 12(c)), the block may comprise RS symbols and data symbols. Some RS symbols convey data through IM. Some RS symbols do not convey data through IM.

In a fourth block configuration (FIG. 12(d)), the block may comprise RS symbols only. All RS symbols convey data through IM. The fine density of the RS symbols at modulation symbol level or at resource element level is equal to 1 (equivalent to all CP-OFDM REs or samples in time carry RS).

In a fifth block configuration (FIG. 12(e)), the block may comprise RS symbols only. Some RS symbols convey data through IM. Some RS symbols do not convey data through IM. The fine density of the RS symbols at modulation symbol level or at resource element level is equal to 1 (equivalent to all CP-OFDM REs or samples in time carry RS).

RS symbols patterns/positions in all configurations could be different (i.e. group RS pattern or distributed RS pattern). RS symbols are on pre-defined fixed positions known for the receiver and the transmitter. The pre-defined fixed positions are reconfigurable.

The second, third, fourth and fifth block configurations may be used as an alternative to the first block configurations.

In contrast to existing techniques using unknown RS symbol positions and where all RS symbols convey jointly a single index through IM, the proposed techniques allow simultaneous

RS and data transmission on some or all RS symbols while having RS symbols on pre-defined known positions for transmitter and receiver. In addition, the proposed techniques may allow implicit data transmission independently per each RS, or jointly on some or all RS symbols. In this way, the proposed techniques may solve firstly the problem of finer density of the RS symbols at RE level or modulation symbol level being equals to one with any waveform (which was without the proposed techniques could lead to zero SE) and the resulting degradations due to unknown RS positions with pilot position IM.

In addition, the proposed techniques may solve different problems (poor coverage, poor estimation accuracy, low estimation frequency, etc.) and may provide different advantages (enhance SE, enhance energy efficiency (EE), reduced transmission power consumption, etc.).

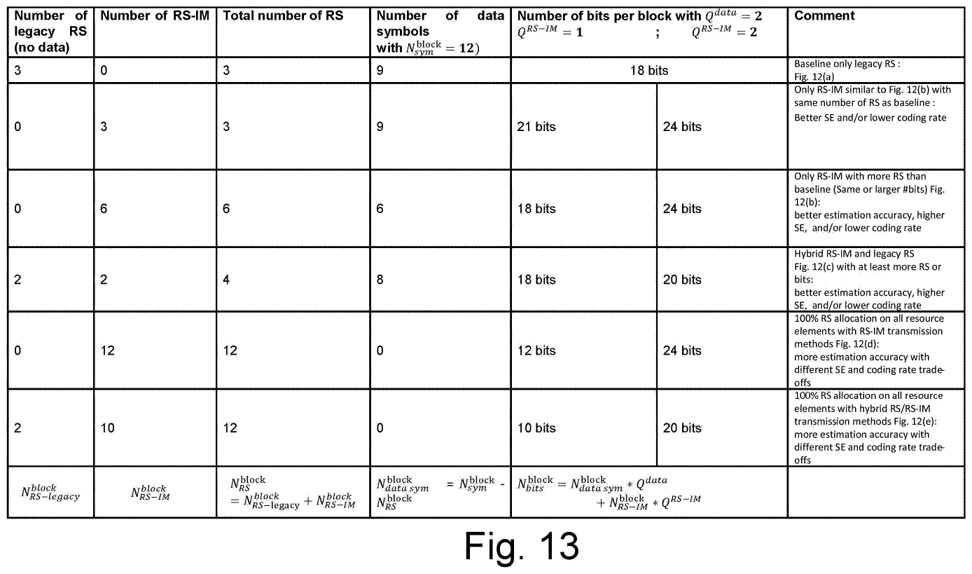

A more detailed example of the different block configurations of FIG. 12 is illustrated in FIG. 13. Each block configuration has 12 modulation symbols (resource element) in total for example. Data symbols may convey 2 bits of data per symbol (e.g. with quadrature phase-shift keying modulation Q^{data}=2 bits/sym)).

The useful data bits per block

$${N}_{info}^{b l o c k}$$

with R coding rate and v layers in multiple input multiple output with SC-FDE system may be:

$${N}_{info}^{b l o c k} = {N}_{b i t s}^{b l o c k} * R * v = ( {N}_{data sym}^{b l o c k} * {Q}^{d a t a} + {N}_{b i t s}^{RS - IM} ) * R * v$$

The fine time (frequency) density at modulation symbol level (resource element level) equal to one with single carrier (multicarrier) may mean

$${N}_{data sym}^{b l o c k} = 0 and {N}_{R s}^{b l o c k} = {N}_{s y m}^{b l o c k} .$$

It may to be clear that

$${N}_{info}^{b l o c k} \neq 0$$

with such RS density if and only if

$${N}_{b i t s}^{RS - IM} \neq 0$$

when the proposed techniques are used. RS symbols may convey independently one or more bits of data per each RS symbol through IM (e.g, Q^{RS-IM}=1 bit/sym, Q^{RS-IM}=2 bits/sym). Then, the number of bits conveyed within RS-IM symbols in a block

$${N}_{b i t s}^{RS - IM}$$

would be any strictly positive integer in general with joint or independent implicit data transmission per RS-IM symbols, and more precisely

$${N}_{b i t s}^{RS - IM} = {N}_{RS - IM}^{b l o c k} * {Q}^{RS - iM}$$

with independent implicit data transmission per each RS-IM symbol. The useful data bits per slot

$${N}_{info}^{s l o t}$$

is the sum or all

$${N}_{info}^{b l o c {k}_{i}}$$

corresponding to the allocated blocks where i=1, . . . ,

$${N}_{block}^{slot}$$

(number of allocated blocks in a slot).

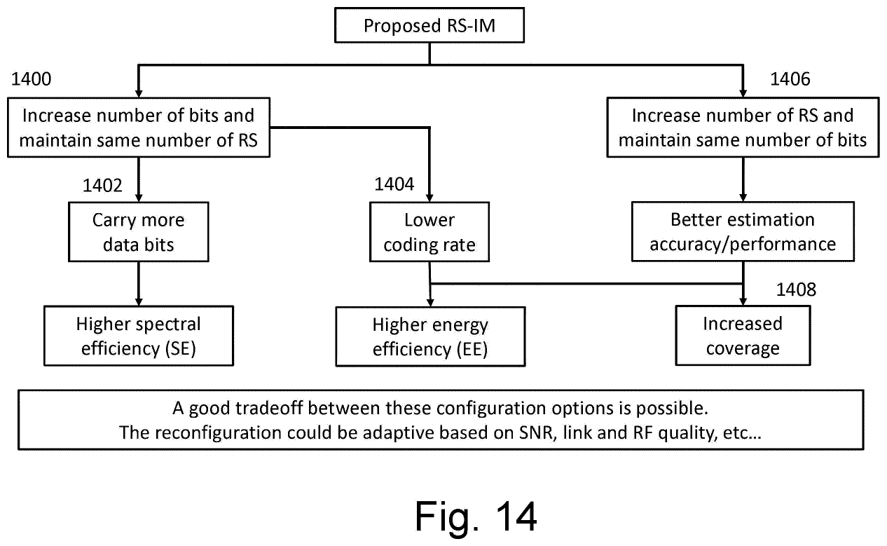

FIG. 14 shows a block diagram of a method for determining a block configuration for a resource block. The block configuration may be determined for example based on at least one of a channel used for transmitting the resource block, a RF impairment at the receiver or transmitter of the resource block or conditions of a link used for transmitting the resource block.

The proposed techniques may transmit data simultaneously on some or all RS symbols through IM.

In a first option the number of RS symbols may be maintained and the number of bits of data conveyed may be increased. These bits may be used to transmit additional data and to enhance SE. These bits may be used to transmit a same data (same SE) and to lower coding rate and enhance EE/coverage.

In a second option the number of RS symbols may be increased and the number of bits of data conveyed may be maintained. The RS symbols may enhance estimation quality especially and may improve coverage and EE.

A trade-off between the above options may be possible.

The underlying advantages of transmit data simultaneously on some or all RS symbols through IM can be described as follows.

The number of RS symbols per block and thus per slot can be raised while keeping at least the same number of bits per slot with same MCS, that is while keeping at least the same transport block size (TBS). Thus, the estimation accuracy can be improved without sacrificing on spectral efficiency or coverage. With better estimations, the communication system may work more efficiently (from an energy perspective) or may increase coverage.

The number of RS symbols per block may be kept constant. Thus, the number of bits per block and thus per slot may be increase. Consequently, when using the additional bits with additional data, the SE and TBS may be increased. The additional bits may as well be used to lower the coding rate and at least one of improve the EE or coverage.

These techniques may be used for UL transmissions since it allows the UE at least one of the following: to reduce the power consumption, increase the coverage without additional transmitter complexity or to enhance SE with same power consumption. These techniques may be used for DL transmissions using any waveform with the same advantages.

The following differences can be mentioned with existing techniques discussed above (see Q. Li, M. Wen, Y. Zhang, J. Li, F. Chen and F. Ji, “Pilot Insertion with Index Modulation for OFDM-Based Vehicular Communications,” 2018 IEEE Global Conference on Signal and Information Processing (GlobalSIP), 2018, pp. 1204-1208, doi: 10.1109/GlobalSIP.2018.8646384 and T. Mao and Z. Wang, “Terahertz Wireless Communications With Flexible Index Modulation Aided Pilot Design,” in IEEE Journal on Selected Areas in Communications, vol. 39, no. 6, pp. 1651-1662 June 2021, doi: 10.1109/JSAC.2021.3071841).

With existing techniques all transmitted RS symbols jointly convey a single index corresponding to the RS symbol positions combination in a slot (e.g. {1,2}, {1,3}, or {2,12} etc.). For clarification, a block with 12 symbols containing 2 RS symbol on variable symbol positions leads to

$$( \begin{matrix}12 \\ 2\end{matrix} )$$

possible combinations and convey

$$⌊ {log}_{2} ( \begin{matrix}12 \\ 2\end{matrix} ) ⌋ = 6$$

bits with the index of selected combination.

In contrast with existing techniques, the proposed techniques may convey an index independently on each RS symbol while keeping the position of the RS symbols fixed and known for the transmitter and receiver. This may lead to a simpler detection by the receiver. This may avoid single point of failure of joint RS symbol indexation that causes wrong estimation and highly degrades the performance if RS symbol positions are mis-detected. This may avoid searching among a huge number of possibilities in the detection.

With the proposed techniques RS symbol with or without IM are on fixed pre-defined positions known to the transmitter and receiver while with existing techniques RS symbol with IM (RS position IM) are on variable positions unknown to the receiver. Any error in RS symbol positions detection may affect the estimation accuracy and the system performance.

With existing techniques there may be difficulty to detect the RS symbol positions and thus difficulty to perform an accurate channel estimation in realistic case (no perfect CSI assumption), to recover the additional bits of data conveyed through IM and then to detect the data symbols.

Any RS pilot position mis-detection with existing techniques may not only affect the bits of data conveyed through IM, but also the channel estimation accuracy and data detection. OFDM with such IM may be worse than classical OFDM of same SE at SE around 2bps/Hz at low signal to noise ratio even with perfect CSI. Similarly, the minimum means square error for channel estimation may be in order of 10⁻² in flat fading channel and larger number of iterations with turbo receiver (not studied in the frequency selective case).

This important degradation with existing techniques may be due to the low channel estimation accuracy when non-RS symbols are used in the estimator. This important degradation with existing techniques may also be due to the attempt of data detection on RS symbol positions which often use different modulation scheme.

3GPP TS 38.211 V17.1.0 section 6.1.2 highlights UL physical signals (DM-RS, PT-RS, SRS) that do not carry information from higher layers. The proposed techniques transmit data simultaneously on some or all RS symbols. In this way, RS symbol overhead may be reduced, coverage or SE may be enhanced. A resource block may comprise a plurality of modulation symbols (resource elements). Each modulation symbol may either be a data symbol conveying data or RS symbol conveying a RS. Each modulation symbol may occupy all reserved frequency resources with single carrier (e.g., DFT-s-OFDM, SC-FDE) or a subcarrier with multicarrier (e.g., CP-OFDM).

It may be noted that it was not possible without the proposed techniques to convey data and a RS jointly on a modulation symbol (resource element) with SC-FDE as in CP-OFDM and DFT-s-OFDM.

Independent pulse shaping indexation modulation may be performed on each RS symbol position. The bits of data may be conveyed by the index of the selected pulse shaping filter. The pulse shaping filter may be changed for each symbol for better SE. The complex symbol on all RS symbol pre-defined positions carries a predefined known RS symbol to be used at the receiver for any estimation (e.g. PTRS/DMRS or both for PN and channel estimations).

A transmitter may select the pulse shaping filter according to bits of data. The transmitter may transmit RS symbols on fixed known positions. Data transmission on RS symbol may only be through IM. Here, it may be through the index of the selected pulse shaping filter. The receiver may detect the selected pulse shaping filter to recover the extra information bits. The receiver may perform at least one of channel or RF impairment (e.g. PN) estimation using the RS symbols on fixed positions. The receiver may compensate any controlled distortion resulting from the used IM technique. The receiver may iterate a turbo receiver to enhance the channel estimation accuracy and performance if necessary. The receiver may equalize and detect data symbols if any.

It may be noted that single carrier systems include by default a pulse shaping filter explicitly as in pure single carrier (e.g. SC-FDE) or implicitly as a kernel of a transform (e.g. kernel in Fourier transforms). This pulse shaping filter may be required to limit the bandwidth occupation. So, the pulse shaping filter indexation has no critical modification for the transmitter compared to conventional single carrier systems. The receiver may be adapted to recover additional bits of data.

The proposed techniques may provide the ability to convey additional bits of data on some or all RS symbols independently to provide the aforementioned advantages. In addition, the proposed techniques may avoid the degradation due the unknown RS symbol positions, and in one embodiment the single point of failure of all RS symbol joint indexation.

It will be understood that the proposed techniques are not limited to pulse shaping filter index modulation. Any other index modulation may be used as long as it has fixed pre-defined RS symbol positions known by both the transmitter and the receiver. The index modulation technique can be performed on each RS symbol independently to convey additional bits of data. This avoids the single point of failure when all RS symbols jointly convey a single index as RS symbol positions and the estimation degradation due to unknown RS symbol positions.

The percentage distribution of RS with or without IM may be anything between 0% an 100% of total number of RS symbols in a block (FIG. 12(a) to FIG. 12(e)).

In addition, the percentage of both RS types may be anything between 0% (block without any RS at all) and 100% of total number of symbols in a block (FIG. 12(d) and FIG. 12(e)).

In an implementation (referred as 100% RS with IM), the percentage distribution between RS symbols configured to convey data through IM may be 100% and the percentage distribution of RS symbols configured to not convey data through IM may be 0%. This may be the preferred implementation to increase the number of RS symbols while maintaining at least the same system SE for better coverage. This may be the preferred implementation to increase the total number of bits while maintaining at least the same number of RS symbols. This increased number of bits may be used to lower coding rate for better coverage or to increase TBS for better SE.

In an implementation (referred as 100% RS without IM) the percentage distribution between RS symbols configured to convey data through IM may be 0% and the percentage distribution of RS symbols configured to not convey data through IM may be 100%. This may be the preferred implementation to reduce receiver constraint. This may be the preferred implementation at high signal to noise ratio when the estimations are accurate enough and the RS symbol overhead is acceptable. This may be also a mandatory backward compatibility configuration for UE/BS without the capability of joint data transmission/reception within RS symbol.

In an implementation (referred as hybrid) the percentage distribution of RS symbols configured to convey data through IM and RS symbols configured to not convey data through IM may be anything between 0% and 100%. The percentage distribution of RS symbols configured to convey data through IM and RS symbols configured to not convey data through IM may be determined based on various parameters, such as characteristics of the channel where a resource block is transmitted or RF impairments. For example, the percentage distribution between RS symbols configured to convey data through IM may be 40% and the percentage distribution of RS symbols configured to not convey data through IM may be 60%. This may be used to have an initial estimation using RS symbols configured to not convey data through IM, and then the RS configured to convey data through IM may be used in the next iteration if needed to enhance estimation quality and thus coverage.

A communication system may be configured to implement the proposed techniques via semi-static or dynamic signaling possibly with hard coded tabularization in the specifications using a combination of physical layer signalling and higher layer signalling (e.g. MAC-CE, RRC signalling). This may be similar to MCS hard coded tables in the specifications where the dynamic signalling may indicate a configuration based on MCS index (e.g., MCS0, MCS1, etc.) and an indicated table. There may be different tables as the MCS case where a table may be indicated semi-statically or dynamically prior to MCS index indication. There may be different tables for joint data and RS related configurations or this may be added to existing tables.

A BS (e.g. gNB) may send a request to a UE to send a report indicating parameters determined by the UE so that a most appropriate block configuration for a resource block may be determined. The BS may receive the report from the UE comprising the parameters determined by the UE. The report may explicitly or implicitly indicate the parameters determined by the UE. The parameters determined by the UE may comprise channel characteristics where the resource block is transmitted, a type of RF impairment experienced by the UE, a level of RF impairment experienced by the UE, conditions of a link used for transmitting the resource block, a UE class or a UE capability. The type of RF impairment may comprise a PN impairment, a doppler spread, a quantization impairment, an in phase and quadrature imbalance impairment, a PA non-linearity, a time jitter or a carrier frequency offset, etc. The parameters determined by the UE may be measured by the UE or known from manufacturing by the UE. A lookup table may define various report lengths and may be used by the UE to generate the report. For example, in-depth reports may be prioritized in poor link quality.

The BS may store reports received from the UE and may maintain an up-to-date list of one or more parameters determined by the UE.

The BS may determine parameters so that a most appropriate block configuration for a resource block may be determined. The parameters determined by the BS may be determined based on transmission between the UE and the BS. The parameters determined by the BS may comprise at least one of a carrier frequency used for transmitting the resource block, a bandwidth allocated to the UE, a MCS used for transmitting the resource block, a variation of a position of the UE, an acknowledgment/non-acknowledgement report for a previous resource block or an estimation derived from RS symbols of a previous resource block.

The BS may determine a need to change a block configuration for a resource block based on at least one of parameters determined by the UE or parameters determined by the BS.

The BS may determine the block configuration for the resource block based on at least one of parameters determined by the UE or parameters determined by the BS. A lookup table may define at least one of various block configurations for various parameters determined by the UE or the BS and may be used by the BS to determine the block configuration.

The BS may receive an indication of a specific block configuration for the resource block from the UE. The specific block configuration may be determined by the UE based on the parameters determined by the UE. The BS may determine the block configuration based on the specific block configuration (i.e. the determined block configuration may be the specific block configuration).

The BS may send an indication of the block configuration to the UE. The indication may be sent explicitly using a new field or using an existing field or implicitly. The indication may be sent in a downlink control information (DCI), a UE-specific or group-specific higher layer signalling (i.e. medium access control (MAC) control element (CE) or RRC signalling). The indication may be sent using the appropriate DCI format.

The indication of the block configuration may comprise an indication of the number of RS symbols. The indication of the block configuration may comprise an indication of the positions in the block of all RS symbols.

The indication of the block configuration may comprise an indication of the number (e.g. expressed as a percentage of the number of all RS symbols) of RS symbols configured to convey data through IM. The indication of the block configuration may comprise an indication of the positions in the block of RS symbols configured to convey data through IM.

The indication of the block configuration may comprise an indication of the number (e.g. expressed as a percentage of the number of all RS symbols) of RS symbols configured to not convey data through IM. The indication of the block configuration may comprise an indication of the positions in the block of RS symbols configured to not convey data through IM.

The indication of the block configuration may comprise an indication of parameters to generate the RS symbols.

The indication of the block configuration may comprise a single bit indicating that all RS symbols are configured to convey data through IM (100% RS without IM) or that all RS symbols are configured to not convey data through IM (100% RS without IM).

The indication of the block configuration may comprise a plurality of bits indicating a pre-selected number (e.g. 2) of RS symbols configured to convey data through IM and a pre-selected number (e.g. 3) of RS symbols configured to not convey data through IM (hybrid). Different combination of bits may indicate different number of RS symbols configured to convey data through IM and number of RS symbols configured to not convey data through IM.

The different number of RS symbols configured to convey data through IM and number of RS symbols configured to not convey data through IM may be based on a trade-off to maintain a same total number of bits per block with more RS symbols compared to baseline legacy configuration using same modulation order (FIG. 12(a)). The different number of RS symbols configured to convey data through IM and number of RS symbols configured to not convey data through IM may be based on a trade-off to increase the total number of bits per block with at least equal number of RS symbols to at least one of enhance SE or enable lower coding rate for better performance.

The indication of the block configuration may comprise an indication of an IM technique for at least one of RS or parameters to configure the IM technique (e.g., pulse shaping filter bank).

The BS may transmit the resource block on the DL according to the block configuration. The BS may transmit the resource block over PDSCH or PDCCH. Alternatively, the UE may transmit the resource block on the UL according to the block configuration. The UE may transmit the resource block over PUSCH or PUCCH.

The proposed techniques may allow to have different RS symbol time/frequency density in a resource block of any waveform (e.g. SC-FDE, DFT-s-OFDM, CP-OFDM). The RS symbol fine time/frequency density may be up to 1 at resource element level. In such case, the resource block may comprise RS symbols and may not comprise data symbols. All RS symbols may be configured to convey data through IM. This may be useful for control channels (e.g., PUCCH, PDCCH) which are critical to enable the communication.

The proposed techniques allow to have a RS symbol fine density at resource element level or modulation symbol level equal to one with any waveform while conveying data information by means of IM within at least one RS to avoid zero SE. Any other RS symbol density may be possible to adapt with the channel and RF impairments conditions.

The proposed techniques may tackle one or more of the above mentioned challenges. The proposed techniques may tackle one or more of the below mentioned challenges.

A challenge may be coverage enhancement by enhancing in general the channel and RF impairments estimation accuracy by using more RS symbols especially at low signal to noise ratio.

Another challenge may be coverage enhancement by increasing a number of data bits conveyed through IM with at least same number of RS symbols and thus allowing smaller coding rate.

Another challenge may be SE enhancement by increasing TBS and reducing RS symbol overhead.

Another challenge may be to enable the estimation of fast-time varying parameters with less RS symbol overhead which may be crucial with high uncorrelated PN changing from symbol to symbol and high doppler spread (small coherence time).

Another challenge may be to enable up to 100% RS symbol allocation on all modulation symbols or resource elements while transmitting data within RS symbols by means of IM. A fine density at resource element level equals 1 is not possible without the proposed techniques.

The proposed techniques focus on single carrier (e.g. DFT-s-OFDM or the like, SC-FDE systems that may be adopted in higher frequencies). However, the proposed techniques may be applied also to multicarrier systems.

The proposed techniques may be applied to all data and control channels carrying RS symbols in UL and DL. The block configuration can be fixed for some channels according to the required reliability especially for the control channel. For instance, PUCCH and PDCCH can use a block configuration for a resource block configuring all RS symbols to convey data through IM as they are more critical. Some formats (e.g. PUCCH/PDCCH formats based on reference signals (not sequence based like PUCCH format 0)) may use a block configuration for a resource block configuring at least one RS symbol to convey data through IM.

In the following, use cases are presented.

In a use case, channel estimation capability may be enhanced whilst allowing for better coverage with high mobility. Using a new signalling process, the UE or BS may detect high speeds. Based on the capability of the UE and the signal quality, the BS may determine a block configuration for a resource block configuring some or all DMRS symbols of the resource block to convey data through IM. By offering more accurate and frequent channel estimates, this may improve coverage when channel coherence times are small and other Rel-17 techniques are not feasible or enough alone (e.g. DMRS bundling, joint channel estimation).

In another use case, phase noise estimation capability may be enhanced whilst allowing for better coverage in higher frequency ranges. When communicating over high frequencies with large bandwidth and low-cost UE, the oscillator PN may be strong and modelled primarily by an uncorrelated distribution (dominant at sub-THz). The BS may determine a block configuration for a resource block configuring some or all PT-RS symbols of the resource block to convey data through IM. In this way, PN may be estimated accurately at some or all s PT-RS symbols independently or jointly to improve coverage in those scenarios.

With the proposed techniques, increasing the number of symbols dedicated to RS could not lead to loss in spectral efficiency in some cases. Indeed, RS symbols can convey data which is not the case with legacy solutions in the standard. So, the proposed techniques may allow to have better estimations, coverage enhancement without any loss in SE (more RS with same TBS) by increasing the number of bits to enable lower coding rate.

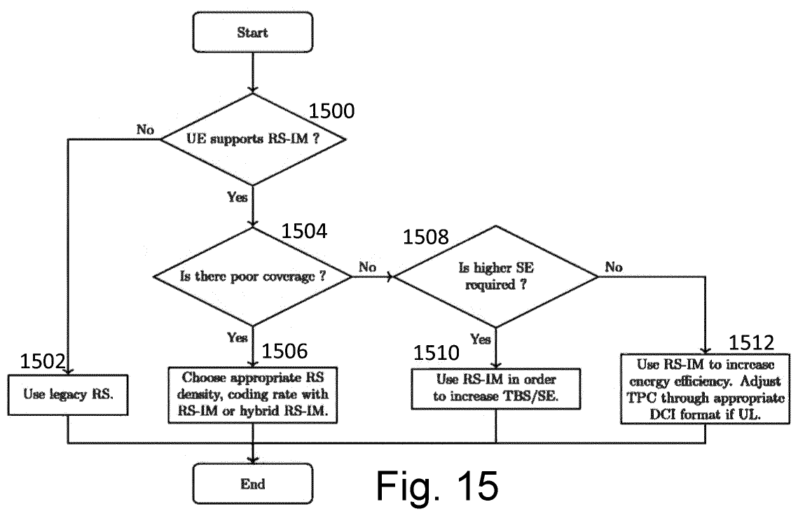

FIG. 15 shows a block diagram of a method for determining a block configuration for a resource block. The method may be performed by a BS (e.g. gNB).

In step 1500, the BS may determine if the UE supports block configurations for a resource block configuring some or all RS symbols to convey data through IM. The determination may be based on an indication received from the UE indicating that the UE supports block configurations for a resource block configuring some or all RS symbols to convey data through IM.

If the UE does not support block configurations for a resource block configuring some or all RS symbols to convey data through IM, the method may go to step 1502. If the UE supports block configurations for a resource block configuring some or all RS symbols to convey data through IM, the method may go to step 1504.

In step 1502, the BS may determine a block configuration for a resource block configuring all RS symbols to not convey data through IM (e.g. FIG. 12(a)).

In step 1504, the BS may determine whether the UE experiences poor coverage. If the UE experiences poor coverage, the method goes to step 1506. If the UE does not experience poor coverage, the method goes to step 1508.

In step 1506, the BS may determine a block configuration for a resource block configuring some or all RS symbols to convey data through IM (e.g. FIGS. 12(b) to 12(e)). The BS may determine the block configuration to increase the number of RS symbols and achieve an appropriate density. The BS may determine the block configuration to increase the number of bits while reducing the coding rate with the capability to maintain the same TBS. The BS may determine the block configuration to increase the number of RS symbols and transmitting the same data to reduce the coding rate (hybrid).

In step 1508, the BS may determine whether higher SE is required. If higher SE is required, the method goes to 1510. If higher SE is not required, the method goes to 1512.

In step 1510, the BS may determine a block configuration for a resource block configuring some or all RS symbols to convey data through IM (e.g. FIG. 12(b) to FIG. 12(e)). The BS may determine the block configuration to increase the number of data bits and increase TBS and SE.

In step 1512, the BS may determine a block configuration for a resource block configuring some or all RS symbols to convey data through IM (e.g. FIG. 12(b) to FIG. 12(e)). The BS may determine the block configuration to increase EE. The BS may adjust a transmission power command (TPC) to lower UE power consumption in UL. The TPC may be sent to the UE through an appropriate DCI format (e.g. format 2_2).

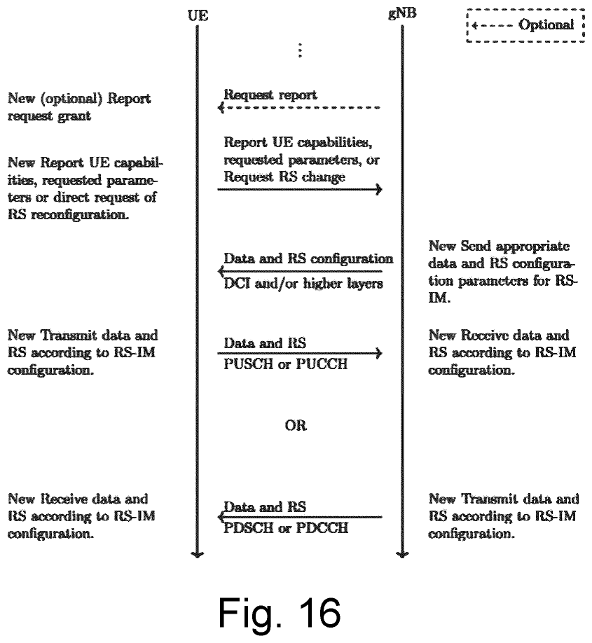

FIG. 16 shows signal diagrams of a process for transmitting and receiving a RS and data over different physical channels.

The BS may send a request to the UE to send a report indicating one or more parameters determined by the UE. The BS may receive the report indicating one or more parameters determined by the UE from the UE. The BS may determine a block configuration for a resource block based on the one or more parameters determined by the UE and one or more parameters autonomously determined by the BS. Alternatively, the BS may receive an indication of a specific block configuration for a resource block from the UE. The BS may determine a block configuration for a resource block based on the specific block configuration.

The BS may transmit an indication of the block configuration for the resource block to the UE. The BS may transmit the indication of the block configuration using DCI or higher layer signalling. The BS may receive a resource block over PUSCH or PUCCH according to the block configuration. The BS may transmit a resource block over PDSCH or PDCCH according to the block configuration

It will be understood that the proposed techniques are not limited to the above aspects.

Other potential IM schemes on RS symbols may be used.

Any modulation can be used on data symbols. This includes conventional modulations (e.g., QAM, PSK, etc.) and even modulation schemes with IM where data can also transmitted by indexing a selected transceiver state (e.g. filter shapes can be used with data symbols to at least one of increase the number of bits for better coverage with lower coding rate or better spectral efficiency).

Any number of layers can be used.

Any data and control channel in UL and DL can adopt this method as long as it needs some RS.

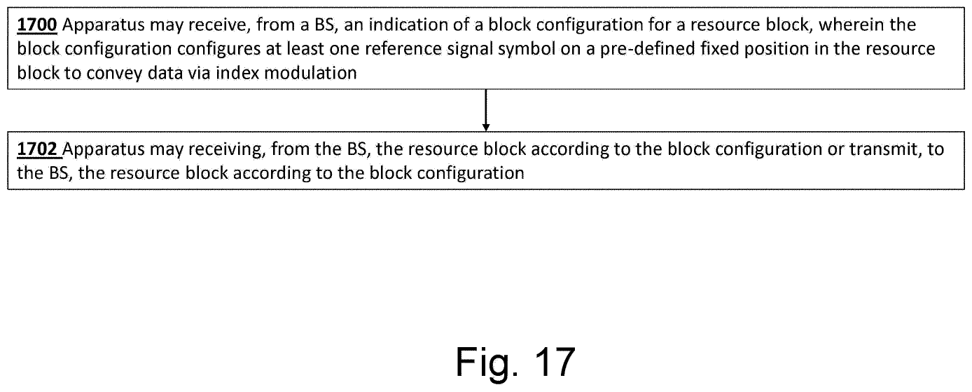

FIG. 17 shows a block diagram of a method for receiving a RS and data performed by an apparatus, for example a UE.

In step 1700, the UE may receive, from a BS, an indication of a block configuration for a resource block, wherein the block configuration configures at least one RS symbol on a pre-defined fixed position in the resource block to convey data via IM.

In step 1702, the UE may receive, from the BS, the resource block according to the block configuration or transmit, to the BS, the resource block according to the block configuration.

The resource block may comprise RS symbols and data symbols. The block configuration may configure all RS symbol on pre-defined fixed positions in the resource block to convey data via IM.

It will be understood that the expressions “data symbols” or “data resource elements” may refer to symbols or resource elements conveying at least an explicit data part (data symbols could have also additional data implicitly via index modulation). The expressions “data symbols” or “data resource elements” may refer to symbols or resource elements not carrying a reference signal.

The resource block may comprise RS symbols and data symbols. The block configuration configures at least one RS symbol on a pre-defined fixed position in the resource block to convey data via IM and at least one other RS symbol on a pre-defined fixed position in the resource block to not convey data via IM.

The resource block may comprise RS symbols and may not comprise data symbols. The block configuration may configure all RS symbol on pre-defined fixed positions in the resource block to convey data via IM or the block configuration may configure at least one RS symbol on a pre-defined fixed position in the resource block to convey data via IM and at least one other RS symbol on a pre-defined fixed position in the resource block to not convey data via IM.

At least one RS symbol on a pre-defined fixed position in the resource block may convey data independently via IM.

At least two RS symbols on pre-defined fixed positions in the resource block may convey data jointly via index modulation.

RS symbols on pre-defined fixed positions known by Tx and Rx in cases FIG. 12(b) to FIG. 12(e) can convey implicit data: independently per RS (e.g. using filter shapes indexation technique or other techniques); or jointly with more than one RS or all RS symbols while keeping RS on same pre-defined positions.

For example with shift index modulation: a known pre-defined DMRS sequence for Tx/Rx (e.g., {s1,s2,s3,s4,s5,s6}) is mapped to pre-defined positions (e.g., {1,3,5,7,9,11} in one resource block or {1,2,3,4,5,6} as FIG. 12(b)). We can have shift index modulation technique where the index of shift applied to sequence at Tx according to information bits conveys implicit data jointly with all RS and the shift index is detected at Rx by a correlator with peak detection for example. Considering four possible shifts of DMRS sequences and one resource block, then two bits may be conveyed jointly by shift index of the sequence and these DMRS symbols may be carried on the pre-defined fixed RS positions:
{s1,s2,s3,s4,s5,s6} conveys 00
{s5,s6,s1,s2,s3,s4} conveys 10
{s3,s4,s5,s6,s1,s2} conveys 01
{s2,s3,s4,s5,s6,s1} conveys 11

So, in this example, RS are still on fixed pre-defined positions and all RS convey jointly data implicitly.

The pre-defined fixed positions of the RS symbols in the resource block may be known by the apparatus and the BS.

The pre-defined fixed positions of the RS symbols may be reconfigurable.

The resource block may be a single carrier resource block or a multicarrier resource block.

The apparatus may transmit, to the BS, at least one of an indication of whether the apparatus supports a block configuration configuring at least one RS symbol on pre-defined fixed position in the resource block to convey data via IM or an indication of at least one parameter determined by the apparatus.

The at least one parameter may be measured by the apparatus or known from manufacturing by the apparatus.

The indication may explicitly or implicitly indicate the at least one parameter.

The apparatus may receive, from the BS, a request to transmit the indication of the at least one parameter.

The at least one parameter may comprise: a channel characteristics where the resource block is transmitted, a type of RF impairment experienced by the apparatus, a level of RF impairment experienced by the apparatus, conditions of a link used for transmitting the resource block, an apparatus class, an apparatus capability.

The type of radio frequency impairment may comprise at least one of a phase noise impairment, a doppler spread, a quantization impairment, an in phase and quadrature imbalance impairment; a power amplifier non-linearity, a time jitter; or a carrier frequency offset.

The apparatus may transmit, to the BS, an indication of a specific block configuration.

The indication of the block configuration may be received, from the BS, via at least one of: UE specific DCI, group specific DCI, MAC CE, RRC configuration of higher layer signaling.

The IM on the at least one RS symbol may be performed by selecting a pulse shaping filter amongst a plurality of pulse shaping filters based on the data to be conveyed.

The resource block may be received, from the BS, over a PDCCH or a PDSCH or transmitted, to the BS over a PUSCH or a PUCCH.

The resource block may be received, from the BS, or transmitted, to the BS, over a frequency band above 71 GHz or below 71 GHz.

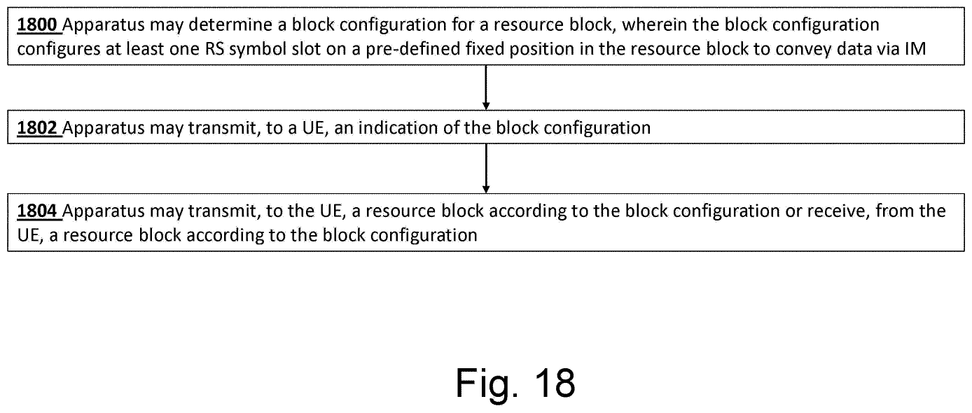

FIG. 18 shows a block diagram of a method for transmitting a RS and data performed by an apparatus, for example a BS.

In step 1800, the apparatus may determine a block configuration for a resource block, wherein the block configuration configures at least one RS symbol slot on a pre-defined fixed position in the resource block to convey data via IM.

In step 1802, the apparatus may transmit, to a UE, an indication of the block configuration. In step 1804, the apparatus may transmit, to the UE, a resource block according to the block configuration or receive, from the UE, a resource block according to the block configuration.

The apparatus may receive, from the UE, at least one of an indication of whether the UE supports a block configuration configuring at least one RS symbol on a pre-defined fixed position in the resource block to convey data via IM or an indication of at least one parameter determined by the UE. The apparatus may determine the block configuration based on the indication.

The apparatus may send, to the UE, a request to send the indication of the at least one parameter.

The apparatus may store the indication of the at least one parameter.

The apparatus may retrieve an indication of at least one parameter determined by the UE for a previous resource block. The apparatus may determine the block configuration based on the at least one parameter.

The at least one parameter may be measured by the UE or known from manufacturing by the UE.

The at least one parameter may comprise at least one of: a channel characteristics where the resource block is transmitted, a type of RF impairment experienced by the UE, a level of RF impairment experienced by the UE, conditions of a link used for transmitting the resource block, a UE class or a UE capability.

The apparatus may determine at least one parameter. The apparatus may determine the block configuration based on the at least one parameter.

The at least one parameter may comprise at least one of: a carrier frequency used for transmitting the resource block, a bandwidth allocated to the UE, a modulation and coding scheme used for transmitting the resource block, a variation of a position of the UE, an acknowledgment/non-acknowledgement report for a previous resource block or an estimation derived from RS symbols of a previous resource block.

The apparatus may receive, from the UE, an indication of a specific block configuration. The apparatus may determine the block configuration based on the specific block configuration.

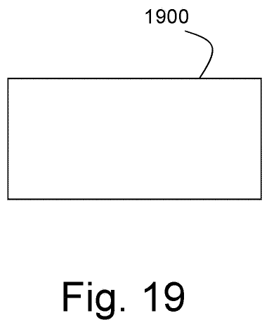

FIG. 19 shows a schematic representation of non-volatile memory media 1900 storing at least one of instructions or parameters which when executed by a processor allow the processor to perform one or more of the steps of the methods of FIGS. 17 and 18.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 17 and 18, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform at least one of one or more of the functions or method steps previously described. That circuitry may be provided in the base station and/or in the communications device.

As used in this application, the term “circuitry” may refer to one or more or all of the following:
(a) hardware-only circuit implementations (such as implementations in only at least one of analogue or digital circuitry);
(b) combinations of hardware circuits and software, such as:
   (i) a combination of at least one of analogue or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying at least one of software or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1.-31. (canceled)

32. An apparatus, comprising:
at least one processor and at least one memory storing instructions that, when executed by the at least one processor, cause the apparatus at least to perform:
receiving, from a base station, an indication of a block configuration for a resource block, wherein the block configuration configures at least one reference signal symbol on a pre-defined fixed position in the resource block to convey data via index modulation; and
receiving, from the base station, the resource block according to the block configuration or transmitting, to the base station, the resource block according to the block configuration.

33. The apparatus of claim 32, wherein the resource block comprises reference signal symbols and data symbols; and
wherein the block configuration configures all reference signal symbol on pre-defined fixed positions in the resource block to convey data via index modulation.

34. The apparatus of claim 32, wherein the resource block comprises reference signal symbols and data symbols; and
wherein the block configuration configures at least one reference signal symbol on a pre-defined fixed position in the resource block to convey data via index modulation and at least one other reference signal symbol on a pre-defined fixed position in the resource block to not convey data via index modulation.

35. The apparatus of claim 32, wherein the resource block comprises reference signal symbols and does not comprise data symbols; and
wherein the block configuration configures all reference signal symbol on pre-defined fixed positions in the resource block to convey data via index modulation; or
wherein the block configuration configures at least one reference signal symbol on a pre-defined fixed position in the resource block to convey data via index modulation and at least one other reference signal symbol on a pre-defined fixed position in the resource block to not convey data via index modulation.

36. The apparatus of claim 32, wherein at least one reference signal symbol on a pre-defined fixed position in the resource block conveys data independently via index modulation.

37. The apparatus of claim 32, wherein at least two reference signal symbols on pre-defined fixed positions in the resource block convey data jointly via index modulation.

38. The apparatus of claim 32, wherein the pre-defined fixed positions of the reference signal symbols in the resource block are known by the apparatus and the base station.

39. The apparatus of claim 32, wherein the resource block is a single carrier resource block or a multicarrier resource block.

40. The apparatus of claim 32, wherein the instructions, when executed by the at least one processor, cause the apparatus to perform:
transmitting, to the base station, at least one of an indication of whether the apparatus supports a block configuration configuring at least one reference signal symbol on pre-defined fixed position in the resource block to convey data via index modulation or an indication of at least one parameter determined by the apparatus.

41. The apparatus of claim 40, wherein the at least one parameter is measured by the apparatus or known from manufacturing by the apparatus.

42. The apparatus of claim 40, wherein the indication explicitly or implicitly indicates the at least one parameter.

43. The apparatus of claim 40, wherein the instructions, when executed by the at least one processor, cause the apparatus to perform:
receiving, from the base station, a request to transmit the indication of the at least one parameter.

44. The apparatus of claim 40, wherein the at least one parameter comprises: a channel characteristics where the resource block is transmitted, a type of radio frequency impairment experienced by the apparatus, a level of radio frequency impairment experienced by the apparatus, conditions of a link used for transmitting the resource block, an apparatus class, an apparatus capability.

45. The apparatus of claim 32, wherein the instructions, when executed by the at least one processor, cause the apparatus to perform:
transmitting, to the base station, an indication of a specific block configuration.

46. The apparatus of claim 32, wherein the indication of the block configuration is received, from the base station, via at least one of: user equipment specific downlink control information, group specific downlink control information, medium access control control element, radio resource control configuration of higher layer signaling.

47. The apparatus of claim 32, wherein the index modulation on the at least one reference signal symbol is performed by selecting a pulse shaping filter amongst a plurality of pulse shaping filters based on the data to be conveyed.

48. The apparatus of claim 32, wherein the resource block is received, from the base station, over a physical downlink control channel or a physical downlink shared channel or transmitted, to the base station over a physical uplink shared channel or a physical uplink control channel.

49. The apparatus of claim 32, wherein the resource block is received, from the base station, or transmitted, to the base station, over a frequency band above 71 GHz; or
wherein the resource block is received, from the base station, or transmitted, to the base station, over a frequency band below 71 GHz.

50. An apparatus, comprising:
at least one processor and at least one memory storing instructions that, when executed by the at least one processor, cause the apparatus at least to perform:
determining a block configuration for a resource block, wherein the block configuration configures at least one reference signal symbol slot on a pre-defined fixed position in the resource block to convey data via index modulation;
transmitting, to a user equipment, an indication of the block configuration; and
transmitting, to the user equipment, a resource block according to the block configuration or receiving, from the user equipment, a resource block according to the block configuration.

51. A method, comprising:
receiving, from a base station, an indication of a block configuration for a resource block, wherein the block configuration configures at least one reference signal symbol on a pre-defined fixed position in the resource block to convey data via index modulation; and
receiving, from the base station, the resource block according to the block configuration or transmitting, to the base station, the resource block according to the block configuration.
